(19) United States
(12) Patent Application Publication
(10) Pub. No.: US 2015/0310300 A1
(43) Pub. Date: Oct. 29, 2015

(54) SYSTEM AND METHOD FOR MULTIPLE OBJECT RECOGNITION AND PERSONALIZED RECOMMENDATIONS

(71) Applicant: DISTILLER, LLC, Kirkland, WA (US)

(72) Inventors: Joshua Hou, Seattle, WA (US); David Golightly, Seattle, WA (US)

(73) Assignee: DISTILLER, LLC, Kirkland, WA (US)

(21) Appl. No.: 14/263,991

(22) Filed: Apr. 28, 2014

(51) Int. Cl. G06K 9/46; G06Q 30/06

(52) U.S. Cl. CPC G06K 9/468; G06Q 30/0631; G06K 9/4642

(57) ABSTRACT

A system and method for multiple object recognition and personalization recommendations is provided that store images data received from a client device in one or more of an electronic memory and a mass-storage device of an application, generating a first data set from the received image data representing a plurality of regions of in a photographic image, each region including objects of a designated type, generating a plurality of object features for each of the objects of the designated type, identifying each of the objects represented in the image data using a plurality of object features and a plurality of object attributes in a second data set, generating a listing of identified objects and a plurality of attributes associated with each of the identified objects, and transmitting to the client device the listing of identified objects and associated objects for generation of an ordered list of personalized recommendations.

### FIELD

The present disclosure relates generally to the field of image processing, and in particular but not exclusively, relates to a system and method for recognizing multiple objects in an image and providing personalized recommendations.

### BACKGROUND

The number of products available to consumers and businesses is growing at an exponential rate and there is an increasing need for personalized assistance for purchasers who seek to identify and select products that satisfy their personal or business wants, needs or likes. As a result of such growth, many consumers, both personal and commercial, are finding that some degree of assistance is needed to help them make more informed decisions that are consistent with their explicit or implicit preferences. When confronted with multiple product options, in some cases it is not readily possible for a purchaser to determine whether a particular product will or will not address their wants, needs or likes. This is particularly true in the case of alcoholic beverages with attractive packaging and strong branding in the marketplace. Indeed, one is left without any definite assurances that a product will satisfy their particular need, want or like until after a purchase has been made. Notwithstanding the growth product number, type and variety, very few solutions exist to provide effective help to prospective purchasers.

In limited instances, image recognition systems have been developed and deployed that can be used to identify individual product shapes in specific locations. Examples include the use of high-speed facial recognition systems that capture and rapidly sort through a database or pre-stored facial images in an effort to identify specific individuals. Other examples include image recognition systems that perform content-based image retrieval for finding specific images with content of interest in a superset of available images as well as systems that estimate the position or orientation of a specific object relative to a camera or other viewing device. In each case, however, the image recognition task is focused on the recognition of a specific object or the recognition of content having a specific identifying criterion.

In addition to image recognition, there are also a dearth of solutions available for object identification. This is particularly true of solutions for identifying multiple objects in an image or other computer-generated representation. One of the more popular and well-known solutions for object identification involves the use of Google Glasses, which is a relatively new product that is used to conduct searches based on pictures taken by handheld devices. In this product, a search can be performed to retrieve information on a specific product or object in a picture taken by a handheld device. However, the product provides no means for conducting searches to retrieve information on multiple objects in a picture. Thus, its utility is limited to performing a series of sequential searches on specially identified objects. As a general matter, object recognition is still a complex subject matter in which active research is still being performed. Various research approaches are being pursued, but few if any have successfully implemented an approach or strategy for efficiently and rapidly identifying multiple objects of the same or different type in an image taken on a handheld device.

In the absence of a fully automated solution, at least one company has provided a resource for researchers and products developers alike to use human reviewers of images where it is not possible for current computer systems to perform image recognition or object identification. One example of such a solution is the Amazon Mechanical Turk (or “MTurk”). The MTurk is a crowd sourcing Internet marketplace that a requesting party can use to have human providers perform tasks that computers cannot perform. Examples of such tasks include choosing the “best” photographs among a pool of several photographs of an object or location, writing descriptions of products, or identifying performers on music CDs. This is a useful service particularly for complex problems where multiple objects are to be identified, but this service hardly provides a viable solution for real-time or near-real time identification of objects taken on a handheld device or other computing platform.

Despite the developments discussed above, prospective customers faced with a bewildering array of product choices remain without a viable solution that can perform image recognition, object identification and provide personalized recommendations based on each customer's unique preferences. Partial solutions exist, but they are limited to single object identification, provide no personalized recommendations, or require human intervention to specifically identify multiple objects that might satisfy a particular need, want or desire. Thus, there is a significant and rapidly growing need for a convenient, fully automated system and method that can perform object recognition and object identification on multiple objects of a given type and provide personalized recommendations on a timely basis.

### BRIEF DESCRIPTION OF THE DRAWINGS

Non-limited and non-exhaustive embodiments are described with reference to the following figures, wherein like reference numerals refer to like parts throughout the various views unless otherwise specified.

FIG. 1 is an illustration of the operating environment for a multi-object recognition and recommendation system in an embodiment.

FIG. 2 is a block diagram illustrating the operative components of a client device used in a multi-object recognition and recommendation system in an embodiment.

FIG. 3 is a block diagram illustrating the operative components of a server used in a multi-object recognition and recommendation system in an embodiment.

FIG. 4 is a block diagram illustrating the operative components of a multi-object recognition and recommendation system in an embodiment.

FIG. 5 is a block diagram illustrating the operative components of a recognition engine used in a multi-object recognition and recommendation system in an embodiment.

FIG. 6 is a flowchart illustrating a process for generating recommendations using a recommendation engine in a multi-object recognition and recommendation system in an embodiment.

FIG. 7 is a flowchart illustrating a process for recognizing and identifying objects using a recognition engine in a multi-object recognition and recommendation system in an embodiment.

FIG. 8 is a flowchart illustrating a process for object recognition in a multi-object recognition and recommendation system in an embodiment.

FIG. 9 is a flowchart illustrating a process for object identification in a multi-object recognition and recommendation system in an embodiment.

### DETAILED DESCRIPTION

In the description to follow, various aspects of embodiments web widgets and the computing and communications system which supports their ability to perform electronic commerce transactions will be described, and specific configurations will be set forth. Numerous and specific details are given to provide an understanding of these embodiments. The aspects disclosed herein can be practiced without one or more of the specific details, or with other methods, components, systems, services, etc. In other instances, structures or operations are not shown or described in detail to avoid obscuring relevant inventive aspects.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

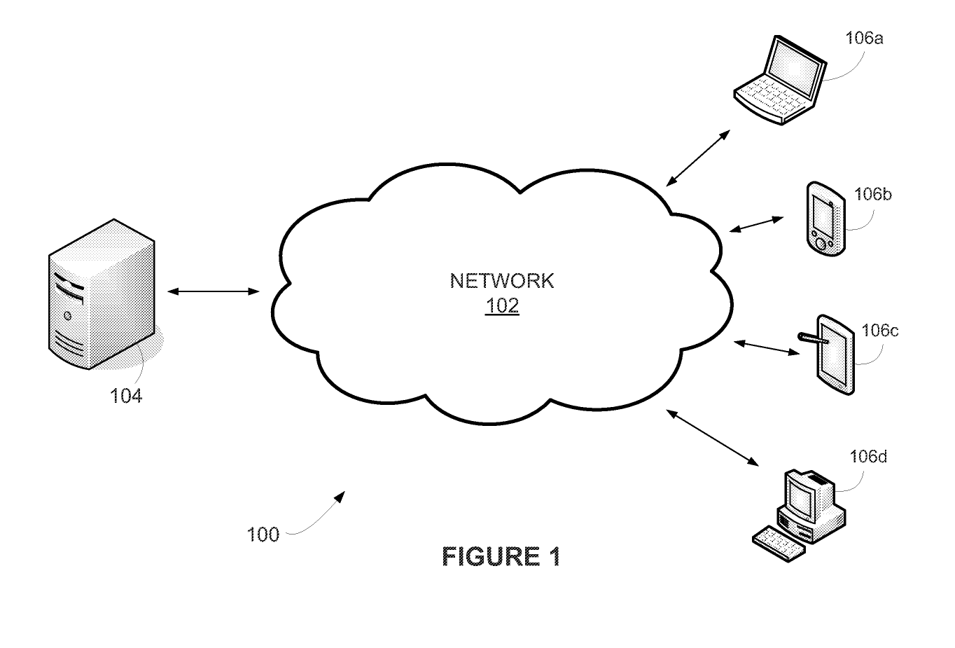

FIG. 1 is an illustration of an operating environment 100 for a multi-object recognition and recommendation system in an embodiment. The operating environment 100 for the system includes one or more client devices 106a, 106b, 106c, 106d which are communicatively coupled over a network 102 to an application server 104. The application server 104 is a computing device including one or more processors, a bus, one or more program memories, one or more secondary storage resources and a network interface controller for receiving and transmitting requesting and data to one or more of the client devices 106a, 106b, 106c, 106d. In the present embodiment, various types of client devices are enabled to execute a portion of the multi-object recognition and recommendation system, including laptop computers 106a, smart phones 106b, personal digital assistants 106c, and desktop computers 106d. Each of the client devices includes at least one or more processors, a bus, one or more program memories, one or more secondary storage resources, and a network interface controller. In the illustrated embodiment, the network 102 is the Internet. In alternative embodiments, the network 102 can be a private computer-communications network (e.g., an Intranet), a wireless communications network, or other computer data communications network that can enable communications between each type of client device and the operative components of the multi-object recognition and recommendation system executed on the application server 106. Although the present embodiment illustrates a system including one application server 104, it should be readily understood by those of ordinary skill in the art that one or more application servers can be used to execute the operative components of the multi-object recognition and recommendation system using a form of distributed processing, or that each operative component can execute one or more processes concurrently on a server that supports multithreaded processing of requests from multiple client devices 106a, 106b, 106c, 106d.

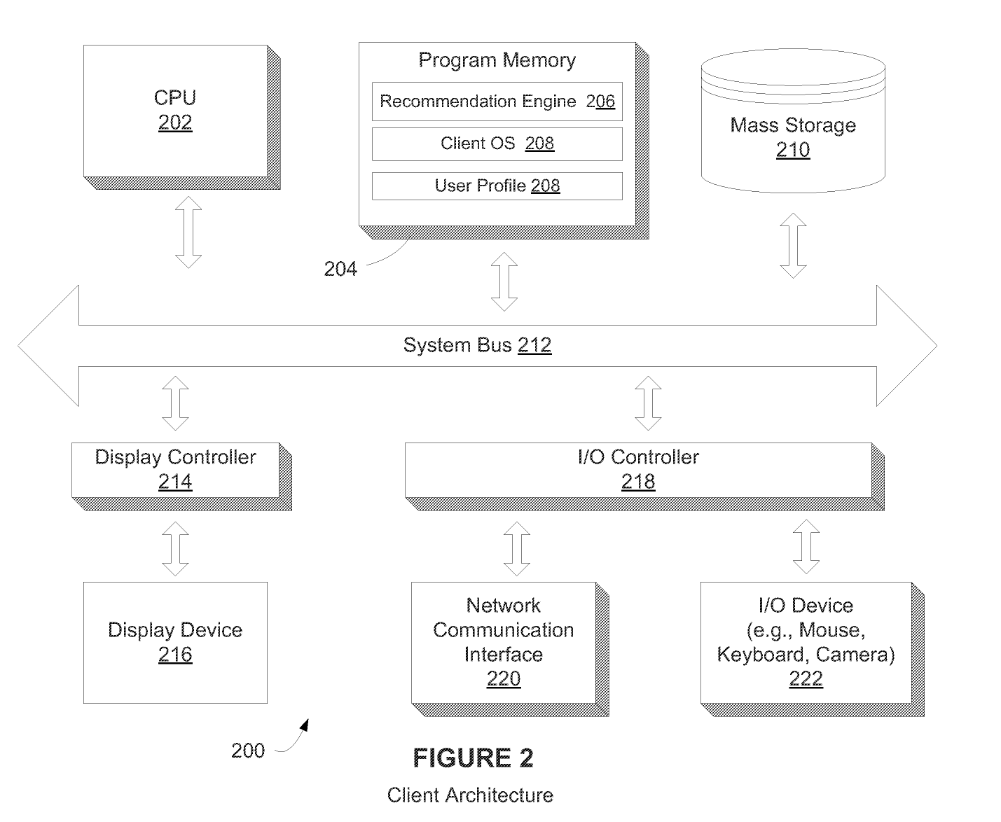

FIG. 2 is a block diagram illustrating the operative components of a client device 200 used in a multi-object recognition and recommendation system in an embodiment. In the illustrated embodiment, each client device 200 includes several interoperating components including a central processing unit (CPU) 202, a program memory 204, a mass storage resource 210 (e.g., external hard disks, etc.), a display controller 214 and an input/output controller 218. Each component of a client device is communicatively coupled to a system bus 212 for the passing of process control messages and/or data. The program memory 204 includes a local client operating system (the “Client OS”) 208, a stored user profile 208, and a recommendation engine 206. The user profile 208 includes one or more records for storing the name, address, email, and one or more telephone number of a user. The user profile 208 also includes a list of stored user preferences pertaining to the objects which are identified in a captured image. In one embodiment, the recommendation engine 206 transmits requests to the application server 104 for the processing of images captured using the camera of a handheld device, such as a smart phone, and generates a rank-ordered list of recommendations based on a listing of objects included in one or more response messages received from the application server 104. In this embodiment, the recommendation engine 206 generates the rank-ordered listing of recommendations by comparing each of the stored user preferences with the attributes associated with each object in the received listing of objects received from the application server 104. The display controller 214 is communicatively coupled to a display device 316 such as a monitor or display on which a graphical user interface (e.g., a browser, etc.) is provided for use by end-users. The input/output controller 218 is communicatively coupled to one or more input/output devices. In the illustrated embodiment, the input/output controller 218 is communicatively coupled to a network communication interface 220 and an input/output device 222 such as a camera, a mouse or a keyboard. In an embodiment, the graphical user interface includes an icon to execute the recommendation engine 206 after a user stores one or more photos taken while using the embedded camera on a client device 200.

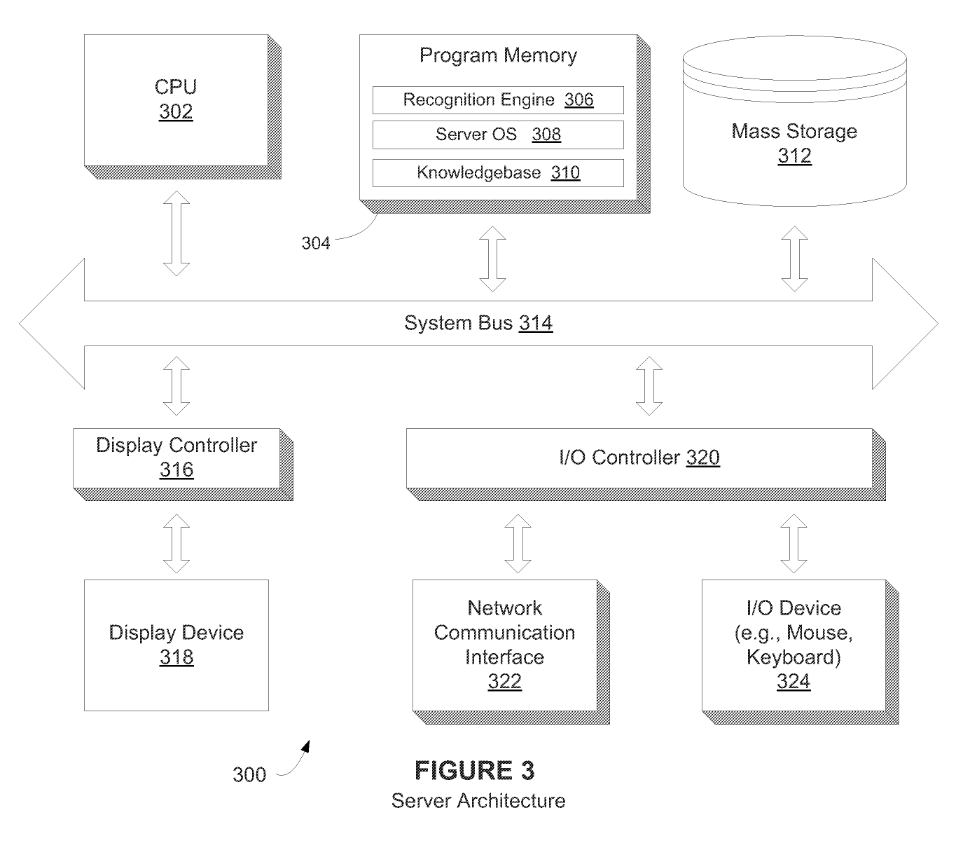

FIG. 3 is a block diagram illustrating the operative components of an application server 300 used in a multi-object recognition and recommendation system in an embodiment. The illustrated embodiment includes a central processing unit (CPU) 302, a program memory 304, a mass storage resource 312 (e.g., external hard disks, etc.), a system bus 314, a display controller 316 and an input/output controller 320. The display controller 316 and the input/output controller 320 are communicatively coupled to the system bus 314. The CPU 302, the program memory 304 and the mass storage device 312 are also communicatively coupled to the system bus 314 for the passing of control instructions and data between operative components and the passing of control messages between processes executing on the operative components. The program memory 304 includes a server operating system 308 (i.e., the “Server OS”), a knowledgebase 310, and a recognition engine 306 that, when executed using the central processing unit 302, performs an object-type recognition process and a object identification process. In performing the recognition and identification processes, the recognition engine 306 sends one or more queries to the knowledgebase 310 requesting data used in one or more classification processes used for object recognition and identification. In one embodiment, two or more concurrently executing instances of each classification process is executed on the processor 302 and the knowledgebase includes an arbiter for controlling concurrent requests for data in the concurrently executing processes. In a different embodiment, the data requests to the knowledgebase 310 are made sequentially for serial execution of each classification process. A process dispatcher executed on the processor 302 is controlled by the recognition engine 306 to enable service requests for the object-type recognition process and the object identification process to be performed iteratively on data representing multiple objects in an image. In addition to the processor and program memory, the server includes a display controller 316 that is communicatively coupled to one or more display devices 318 on which, in one embodiment, the status of completed processes executed on the processor 302 are displayed. An input/output controller 320 is also provided and it is communicatively coupled to one or more input/output devices. In particular, the input/output controller 320 is communicatively coupled to a network communication interface 322 and one or more input/output devices 324, such as a mouse or keyboard. In one embodiment, the network communication interface 322 (i) receives digitized images captured from cameras or other photo capture devices used on client devices upon which one or more object recognition and identification processes are to be applied and (ii) transmits listings of recognized objects and their associated attributes in the captured images.

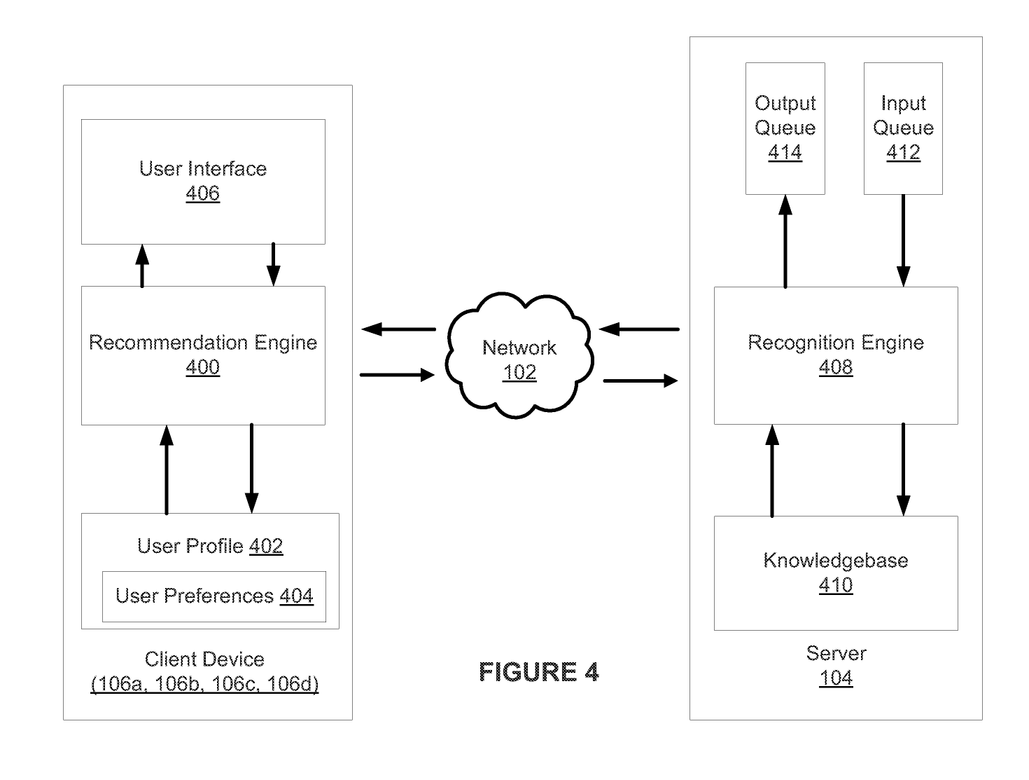

FIG. 4 is an illustration of the operative components of a multi-object recognition and recommendation system in an embodiment. This system is used to transform raw user image data into specific and highly personalized recommendations on the products of a given type in a photo image which has been converted into user image data. In this embodiment, a client device 106 executes several processes and uses certain stored data. In the illustrated embodiment, the client device 106 executes a recommendation engine 400 upon receipt of a request for a list of recommendations pertaining to a particular type of object. A user causes a request to be generated after a photo image is taken from a camera, such as a conventional embedded digital camera in a handheld device (e.g., smart phone, iPad, tablet computer, etc.) is stored in a local memory of the client device 106. More specifically, in an embodiment, a request for recommendations from recommendation engine 400 is placed once a user clicks on an icon displayed on the user interface 406. In an alternative embodiment, the request for recommendations is placed when a user executes a speech-activated request that causes the execution of the recommendation engine 400. Once activated, the recommendation engine 400 retrieves the stored image data and transmits it in a data package over a network 102 to an input queue 412 on the server 104 for processing on a recognition engine 408. In an embodiment, the data package is comprised of one or more data packets each of which includes a list of identified bottles and associated coordinate rectangles in a subject image.

In an embodiment, a process dispatcher executes the server that monitors the arrival of new data packages in the input queue 412 and the transmission of object lists stored in the output queue 414. When the process dispatcher detects a new input data package in the input queue 412, a message is sent to the recognition engine 408 that causes the data package to be retrieved, read and processed. In processing the data package, the recognition engine executes one or more statistical classification algorithms that rely upon image data in the data package and training image data stored in a knowledgebase 410. In one embodiment, as each data packet is processed in the data package, the recognition engine 408 applies, compares and statistically correlates characteristics of objects in the image data to the pre-stored attributes of objects in the set of training image data. In an embodiment, the training image data is refreshed and updated on at least a daily basis to ensure that the recognition engine 408 is consistently and accurately classifying attributes of objects of a given type. The rate at which such updating is performed is controlled in part by the frequency with which users enter new images in the input queue 412 and the processing throughput of the recognition engine 408. In one embodiment, the training data is used by the classifier executed in the recognition engine 408 to classify attributes of bottles of alcoholic beverages such as whiskey bottles, bourbon bottles, gin bottles, vodka bottles, or other alcoholic spirits. In a preferred embodiment, the knowledgebase 410 is implemented as an object-oriented database management system wherein training image data is stored in objects. In alternative embodiments, the knowledgebase 410 is implemented as either an hierarchical database management system or a relational database management system. Thus, as the recognition engine processes successive portions of the user image data, new data retrieval calls are made to the knowledgebase 410 and successive portions of training image data are transmitted to the recognition engine 408 in response to these requests. The training image data is used to the help classify distinguish between different types of objects in an image set and the user image is correlated to classified training image data to enable objects to be distinguished in the user image data with a satisfactory degree of statistical significance.

After the user image is processed and objects of a specific type (e.g., whiskey bottles, etc.) in the image statistically correlated to object attributes in the training image data, the objects that have been both recognized and identified are included in a list of objects that is stored in the output queue 414 by the recognition engine 408. The process dispatcher then sends a control message to a network interface controller that causes the list of objects and related attributes stored in the output queue 414 to be transmitted over the network 102 to the recommendation engine 400 on the client device from which the initial request for object recognition and object identification was received. The recommendation engine 400 performs a comparison of the attributes of each object in the user image data to a user's preferences stored on the client device 106 as a part of a user profile 402. In one embodiment, the objects recognized are whiskey bottles, and the specific objects identified are various types of whiskey beverages (e.g., Jack Daniels, Wild Turkey, Jim Beam, Four Roses, etc.). An ordered listing of objects in the user image data is generated by the recommendation engine 400 from a comparison of object attributes and stored user preferences which are subsequently used to generate a flavor recommendation graph and an ordered listing of objects for a user's consideration ranked in order of taste preference on the user interface 406.

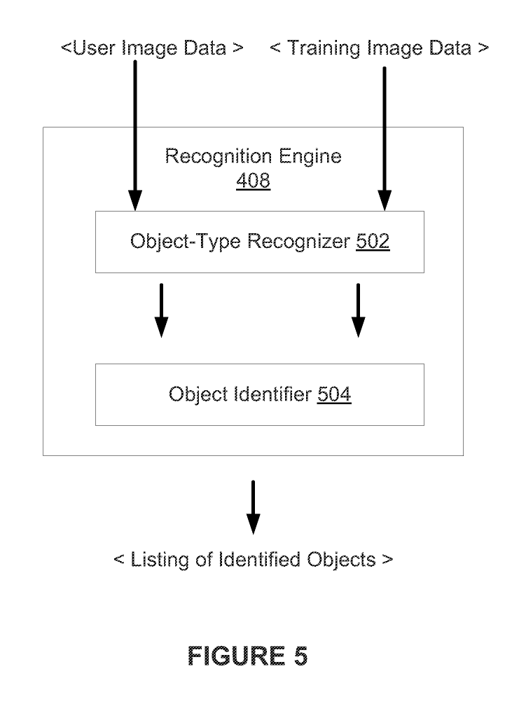

FIG. 5 is a block diagram illustrating the operative components of a recognition engine 408 used in a multi-object recognition and recommendation system in an embodiment. In this embodiment, the recognition engine 408 is comprised of an object-type recognizer 502 that is communicatively coupled to an object identifier 504. The object-type recognizer 502 is a statistical classifier that receives as input user image data representing a photographic image and training image data. The training image data includes feature-specific attributes of objects of a pre-determined type for a given domain. In one embodiment, the training image data is comprised of manually accumulated images from various liquor and grocery stores. These images are annotated to indicate each region of interest containing a bottle. Afterwards, the annotations are cropped out, scaled and color-balanced and then split into YUV color channels where one or more feature extractors are applied to the data. One category of feature extractors applied are Viola-Jones shape detectors that use LBP (“local binary pattern”) extractors and HOG feature extractors (“histogram of oriented gradients”) for training purposes. An alternative category of feature extractors use an SVC-based identifier that applies DAISY feature extractors and HOG (“histogram of oriented gradients”) feature extractors for training purposes. A third alternative feature extractor that is applied is the Scale Invariant Feature Transform (“SIFT”) and it is used to identify key points of interest (e.g., corners of high contrast) and to match them between two given images for training purposes. One embodiment of a three-step process used to apply these features extractors comprises (i) finding a color space that represents the greatest contrast between color bands and between overall luminance and darkness, (ii) taking each image channel individually and expressing it as a grayscale matrix, and (iii) extracting contrast-based features from each channel. The selected feature extractors are preferable since they process data based on detected corners and edges as such structures tend to offer the most robust features for grayscale imaging and these feature extractors are also generally impervious to rotation and scale.

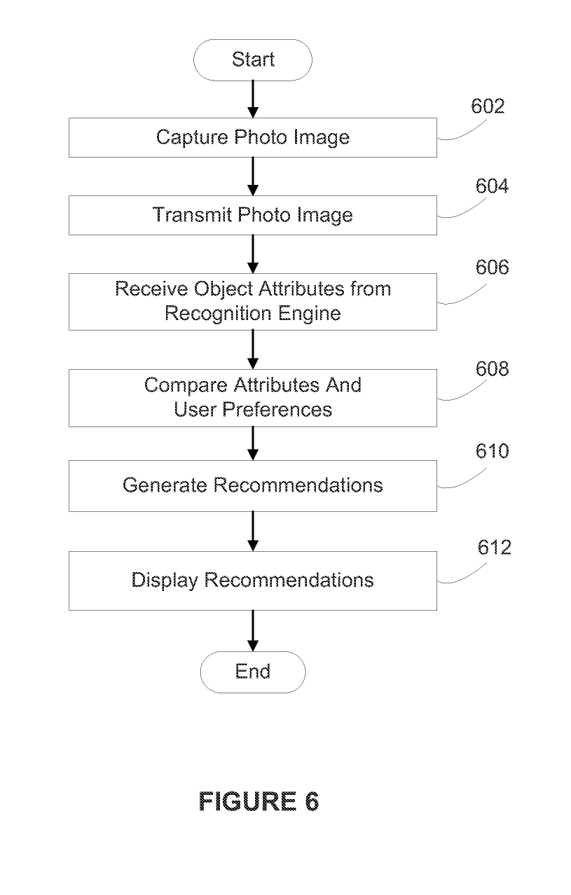

FIG. 6 is a flowchart illustrating a process for generating recommendations using a recommendation engine in a multi-object recognition and recommendation system in an embodiment. In the illustrated embodiment, a digitized photographic image is captured, as shown at step 602, and stored in a data package that includes one or more data packets. The data package is then transmitted to an application server, as shown at step 604, where the digitized image is further processed on an application server. The recommendation engine transmits the digitized image to an application server executing a recognition engine to be sent in return a listing of objects and attributes of objects appearing in the digitized image. After transmission of the digitized image to an application server, one or more object attributes are received from a recognition engine executed on the application server, as shown at step 606. The attributes in the received data are then compared with user preferences that are pre-stored in a local memory, as shown at step 608. Upon completion of the comparing of object attributes to user preferences, the recommendation engine generates an ordered list of recommendations for an end user, as shown at step 610. The ordered list of recommendations not only identifies objects in the digitized image of a particular designated type but also includes subjective descriptions of the attributes and/or qualities of the identified objects. These subjective descriptions provide a user with relevant details on why an object has been placed in its position in the ordered list. In one embodiment, the objects identified in the ordered listing are bottles of whisky, including various types of American whiskey, Scottish whisky and Irish whisky. Each bottle whisky in the ordered list is listed with a subject description of its qualities based on the attributes previously assigned to it by an expert whisky taster. The attributes used to describe and/or characterize a whiskey are those generally used by expert whisky tasters and include descriptors such as: sweet, smoky, rich, peaty, herbal, spicy, floral, vanilla, full-bodied, oily, fruity, tart, briny and salty. The attributes used in characterizing a whiskey also include the perceived popularity of the product (e.g., based on frequency of selection counts, etc.), the expert's overall rating, and the user's stored ratings in the system. After the comparing of attributes and the generation of recommendations, an ordered list of recommendations is displayed on a user interface of a client device for review by an end user, as shown at step 612. In one embodiment, the user interface displays a flavor graph to graphically illustrate the flavor or taste qualities of each whisky (or American whiskey) on the ordered list of recommendations. In this embodiment, several independent personalized recommendation pages are provided with each page displaying one or more pictures of a recommended beverage and a flavor graph that illustrates the subjective taste quality or qualities of the recommended beverage in a graphical form. In an alternative embodiment, the flavor graph is functionally coupled to each recommendation page and used to receive requests for specific beverages on the ordered list of recommendations. An end-user can place a request by touching or speaking a preferred flavor on the graph shown on the user interface. This request will cause the recommendation engine to search over the set of entries in the ordered list and cause the recommendation page showing an object (e.g., an alcoholic beverage, etc.) with the closest match to the requested flavor to be displayed first in the set of recommendation pages created from the ordered list of recommendations.

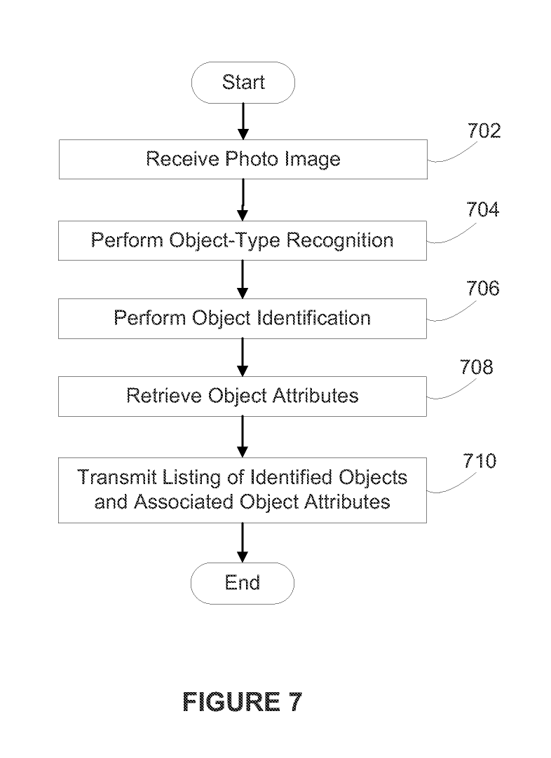

FIG. 7 is a flowchart illustrating a process for recognizing and identifying objects using a recognition engine in a multi-object recognition and recommendation system in an embodiment. In the illustrated embodiment, a digitized photographic image is received from a client device, as shown at step 702, in a data package comprised of one or more data packets. The recognition engine processes that data package and performs an object-type recognition process to systematically identify relevant features and objects within the digitized image using a series of image processing methods, as shown at step 704. In particular, object-type recognition involves a high-level categorization of the image viewing field to identify regions where objects of a particular type are located. This initial level of processing is called “blob detection,” in one embodiment, as it is performed to identify regions of interest that include one or more objects of a designated type. After the initial object-type recognition is completed, using the regions that were identified during the recognition process, one or more steps are performed to achieve object identification, as shown at step 706. The object identification process includes a feature extraction step and a feature matching step. In performing these steps, the object identification process systematically evaluates the regions within the image (also known as “blobs”) that were identified during the recognition step and applies algorithms to determine localized object appearance using intensity gradients or edge directions to more specifically identify the types of objects in these regions. After completion of the object identification process, the attributes of the objects that are identified in the digitized image are retrieved from a local memory, as shown at step 708, and a consolidated listing of identified objects and their associated attributes is compiled and transmitted to a client device executing a recommendation engine where the data in the listing will be used to generate an ordered list of recommendations for an end-user, as shown at step 710.

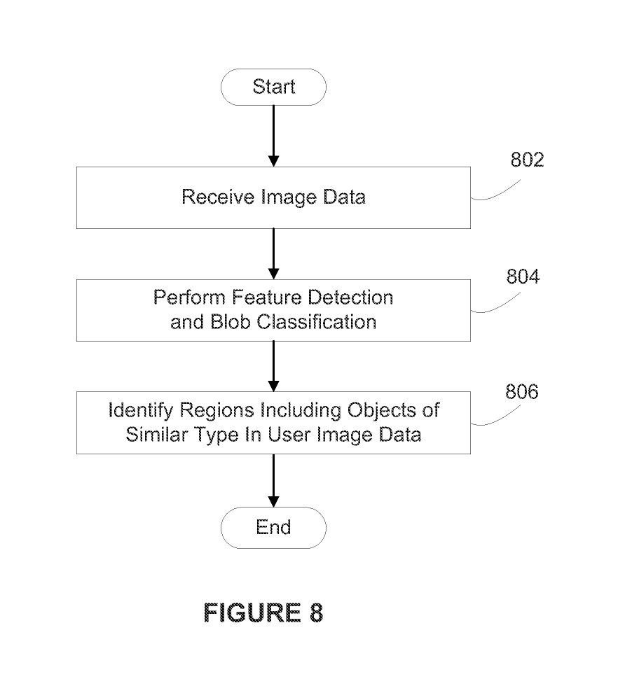

FIG. 8 is a flowchart illustrating a process for object recognition in a multi-object recognition and recommendation system in an embodiment. In the illustrated embodiment, the object-type recognition process begins with the receiving of photographic image data, as shown at step 802. Photographic image data includes a digitized representation of an image taken by a handheld camera or other optical device that is capable of digitizing an image. Digitized images are comprised of data that represents the field of view in a picture in the form of pixels. Each pixel includes information expressed in the form of grayscale levels that are useful in identifying certain structural and orientation features or aspects, respectively, of objects appearing in the photographic image. The object-type recognition process uses the grayscale levels of pixels in a digitized photographic image to perform one or more feature detection processes and a blob classification process to identify specific regions within the digitized image that include information of value and that relate to the specific types of objects for which the recognition engine has been trained to identify, as shown at step 804. After completion of the one or more feature detection processes and the blob classification process, relevant regions of the digitized image are identified which include objects of a similar type in the user image data, as shown at step 806. Once the regions in which objects of interest have been identified, the recognition engine then proceeds to perform a series of higher-level feature extraction and feature matching processes.

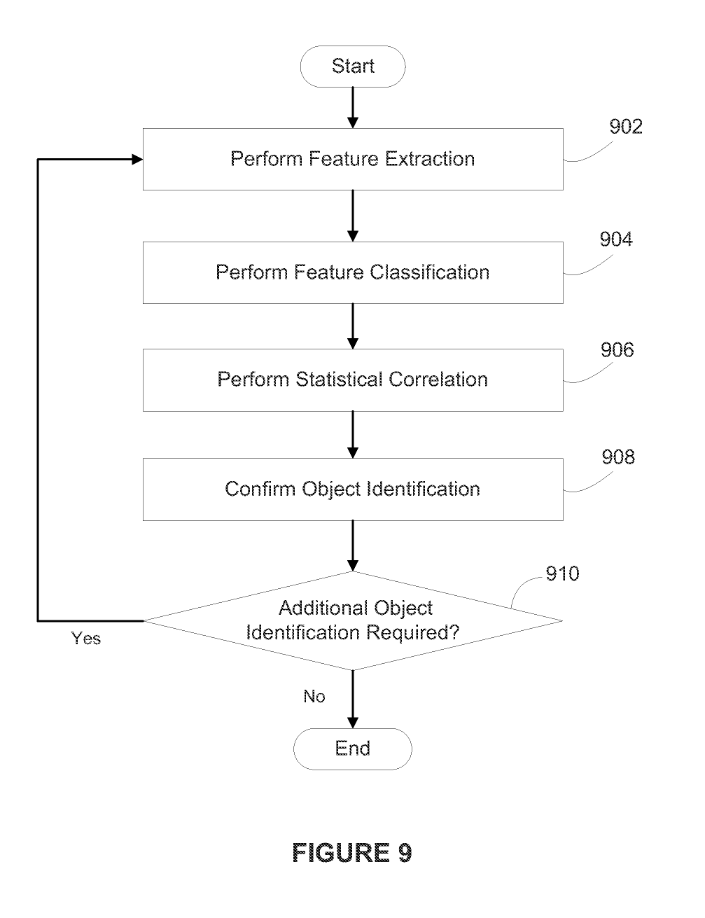

FIG. 9 is a flowchart illustrating a process for object identification in a multi-object recognition and recommendation system in an embodiment. In the illustrated embodiment, a feature extraction process is performed, as shown at step 902, using one or more algorithms to identify relevant features of objects of a designated type displayed in a photographic image. In one preferred embodiment, the feature extraction process employs Histogram of Oriented Gradients (“HOG”) descriptors (the “HOG descriptors”) in a first phase and then applies DAISY descriptors in a second phase. In this embodiment, HOG descriptors are used to identify intensity gradients or edge directions. DAISY descriptors further refine the results by applying one or more smoothing filters to the histograms generated using the HOG descriptors. After relevant features are extracted from the image, a pattern recognition algorithm is applied to the extracted features using a support vector model classifier to enable the features to be classified to a higher degree of statistical significance, as shown at step 904. After feature classification, a statistical correlation process is performed to correlate features to attributes of objects in a digitized image having the classified features, as shown at step 906. The correlation process is performed using extracted features in a first data set and attributes of objects in a set of training image data comprising a second data set. Collectively, feature classification, feature/attribute correlation, and object identification comprise a feature matching process performed in one embodiment of the recognition engine.

Each recognition engine must be trained to recognize the specific objects of interest to a user. Thus, an end-user must provide sample images including relevant objects of interest to enable the statistical correlation engine used in the recognition engine to identify and compile data including the attributes of objects of a designated type of interest to the end-user (e.g., bottles of whisky, bottles of rum, bottles of cognac, etc.). The recognition engine, therefore, is operative in two different operational modes, a training mode and an analysis mode. The training mode enables the development of a second set of data that includes attributes for associated objects and information on the shape and appearance (e.g., edge orientations, intensity gradients, etc.) of features for associated objects, upon which the correlation process can be applied in the analysis mode to achieve statistically significant correlation results.

After feature classification and statistical correlation, the recognition engine then performs an object identification process for each object within an analyzed region, as shown at step 908. In one embodiment, this process is performed iteratively over several different blobs or regions in a digitized image to confirm the identification of all objects of a designated type. For example a photographic image may include multiple bottles of whiskey (e.g., such as Wild Turkey whiskey, Jack Daniels whiskey, etc.). Each of the bottles may have distinctly different shapes as a means of differentiating them from other competing products of the same type in the same spatial region. The recognition engine performs the feature extraction step (step 902) and each of the steps in the feature matching phase (steps 904, 906 and 908) on an iterative basis to analyze each object appearing in each region or blob of a photographic image. The iterative nature of this process is represented at the decision point where the recognition engine queries to confirm whether any additional objects require identification in the photographic image, as shown at step 910. If there no further objects require processing, the recognition process will terminate. If additional objects are identified that require further analysis, the feature extraction process will be repeated as shown at step 902 (feature extraction) and each of the three steps involved in the feature matching process, feature classification (step 904), statistical correlation (step 906) and object identification (step 908), will be executed. Each step will be executed until all object data has been processed and all objects of the designated type identified in the photographic image. After identification of all objects, the recognition process will then terminate.

Although specific embodiments have been illustrated and described herein, it will be appreciated by those of ordinary skill in the art that a wide variety of alternate and/or equivalent implementations may be substituted for the specific embodiments shown and described without departing from the scope of the present disclosure. This application is intended to cover any adaptations or variations of the embodiments discussed herein.

What is claimed is:

1. A method comprising:
storing image data received from a client device in one or more of an electronic memory and a mass-storage device of an application server;
generating a first data set from the received image data, the first data set representing a plurality of regions in a photographic image represented in the received image data, each region including one or more objects of a designated type;
generating a plurality of object features for each of the one or more objects of the designated type from the first data set;
identifying each of the objects represented in the received image data using the plurality of object features and a plurality of object attributes in a second data set;
generating a listing of the identified objects and a plurality of attributes associated with each of the identified objects; and
transmitting to the client device the listing of the identified objects and the associated attributes.

2. The method of claim 1 wherein the client device is at least one of a smart phone, a laptop computer, a desktop computer and a personal digital assistant.

3. The method of claim 1 wherein the identifying of each of the objects represented in the received image data comprises:
applying a pattern recognition algorithm to the plurality of object features and information in the second data set for feature classification;
applying a statistical correlation algorithm to correlate each of the classified object features to the plurality of object attributes; and
confirming identification of each object from the statistical correlation of the classified object features to the object attributes.

4. The method of claim 1 wherein the second data set includes a plurality of training image data for objects of the designated type.

5. The method of claim 4 wherein the designated type is a bottled alcoholic beverage.

6. The method of claim 5 wherein the bottled alcoholic beverage is at least one of an American whiskey, an Irish whisky, and a Scottish whisky.

7. The method of claim 1 wherein the generating of the plurality of object features is performed using one or more feature extraction descriptors, the one or more feature extraction descriptors being at least one of a Histogram of Oriented Gradients descriptor and a DAISY descriptor.

8. An apparatus for recognizing objects in image data, the apparatus comprising:
a communication bus;
a network interface controller coupled to the communication bus;
one or more electronic memories coupled to the communication bus;
one or more mass-storage devices coupled to the communication bus;
a processor coupled to the communication bus and communicatively coupled to the one or more electronic memories and the one or more mass-storage devices;
computer instructions, stored in the one or more electronic memories and one or more of the mass-storage devices that, when executed by the processor, control the apparatus to:
store image data received from a client device in one or more of the electronic memories and the mass-storage devices;
generate a first data set from the received image data, the first data set representing a plurality of regions in a photographic image represented in the received image data, each region including one or more objects of a designated type;
generate a plurality of object features for each of the one or more objects of the designated type from the first data set;
apply a recognition process the plurality of object features and a plurality of object attributes in a second set of data to identify each of the objects represented in the received image data;
generate a listing of the identified objects and a plurality of attributes associated with each of the identified objects; and
transmit to the client device using the network interface controller the listing of the identified objects and the associated attributes.

9. The apparatus of claim 8 wherein the client device is at least one of a smart phone, a laptop computer, a desktop computer and a personal digital assistant.

10. The apparatus of claim 8 wherein the recognition process executed by the processor controls the apparatus to:
apply a pattern recognition algorithm to the plurality of object features and information in the second data set for feature classification;
apply a statistical correlation algorithm to correlate each of the classified object features to the plurality of object attributes; and
confirm the identification of each object from the statistical correlation of the classified object features to the object attributes.

11. The apparatus of claim 8 wherein the second data set includes a plurality of training image data for objects of the designated type.

12. The apparatus of claim 11 wherein the designated type is a bottled alcoholic beverage.

13. The apparatus of claim 12 wherein the bottled alcoholic beverage is at least one of an American whiskey, an Irish whisky, and a Scottish whisky.

14. The apparatus of claim 8 wherein the plurality of object features are generated using one or more feature extraction descriptors, the one or more feature extraction descriptors being at least one of a Histogram of Oriented Gradients descriptor and a DAISY descriptor.

15. An apparatus for generating personalized recommendations on recognized objects in a digitized image, the apparatus comprising:
a communication bus;
one or more electronic memories coupled to the communication bus;
one or more mass-storage devices coupled to the communication bus;
a processor coupled to the communication bus and communicatively coupled to the one or more electronic memories and the one or more mass-storage devices;
computer instructions, stored in the one or more electronic memories and one or more of the mass-storage devices that, when executed by the processor, control the apparatus to:
receive from an application server a listing including a plurality of objects identified in the digitized image and a plurality of associated attributes;
compare the plurality of associated attributes to a plurality of user preferences stored in at least one of the one or more electronic memories and the one or more mass-storage devices;
generate an ordered listing of objects and a personalized recommendation for each object in the ordered listing based on the stored plurality of user preferences for an end-user; and
display the ordered listing and each personalized recommendation on a graphical user interface according to the stored plurality of user preferences.

16. The apparatus of claim 15 wherein each of the objects is a bottled alcoholic beverage.

17. The apparatus of claim 16 wherein the bottled alcoholic beverage is at least one of an American whiskey, an Irish whisky, and a Scottish whisky.

18. The apparatus of claim 15 wherein the user preferences comprise one or more user taste preferences.

19. The apparatus of claim 16 wherein each of the objects have at least one of the associated attributes and each attribute is a taste preference for the bottled alcoholic beverage.

20. The apparatus of claim 15 wherein the graphical user interface displays a plurality of recommendation pages, a flavor graph, and one of the personalized recommendations for a bottled alcoholic beverage on each of the recommendation pages.
